(19) United States
(12) Patent Application Publication
(10) Pub. No.: US 2002/0109981 A1
(43) Pub. Date: Aug. 15, 2002

(54) Lighting device for footwear articles

(76) Inventor: Gianfranco Amici, Milano (IT)

Correspondence Address: James V. Costigan, Esq., HEDMAN & COSTIGAN, P.C., Suite 2003, 1185 Avenue of the Americas, New York, NY, 10036-2646, US

(21) Appl. No.: 10/072,025

(22) Filed: Feb. 7, 2002

(30) Foreign Application Priority Data
Feb. 9, 2001 (IT) MI2001A 000276

(51) Int. Cl. F21V 21/08; A43B 23/00

(52) U.S. Cl. 362/103; 36/137

(57) ABSTRACT

A lighting device for footwear articles comprises a holding body designed for application to a footwear article, by a resilient clip, and for holding therein lighting elements supplied by one or more power supply batteries, and driven by a seismic switch, in turn controlled by a crepuscular switch, designed for supplying power only as the environment brightness level is less than a set value.

The device comprises a timer actuated by the seismic switch and designed for switching off the power supply, after a given seismic switch rest time.

### BACKGROUND OF THE INVENTION

The present invention relates to a lighting device, specifically designed for application to footwear articles, such as slippers and the like.

As is known, a person waking in the night, in the dark, cannot frequently switch-on the lighting lamps, in order not to disturb other slipping persons, or since the room is devoid of lighting means, or since, for example in a hotel room, the user does not precisely know the location of the power sockets and furniture pieces through the room.

### SUMMARY OF THE INVENTION

Accordingly, the aim of the present invention is to overcome the above mentioned problem, by providing a lighting system which can be easily and quickly driven by the user.

Within the scope of the above mentioned aim, a main object of the invention is to provide such a lighting device which has a small weight and size.

Another object of the present invention is to provide such a lighting device which is designed for automatically operating, as it is required, without any operations by the user.

According to one aspect of the present invention, the above mentioned aim and objects, as well as yet other objects, which will become more apparent hereinafter, are achieved by a lighting device, characterized in that it comprises a holding body designed for application to a supporting element, forming a portion of a footwear article, by a resilient clip, and comprising lighting means power supplied by one or more power supply batteries and driven by a seismic switch, which is in turn controlled by a crepuscular switch.

The crepuscular switch is designed for allowing electric power to be supplied only as the environment brightness level is less than a set value, timer means being moreover provided, actuated by the seismic switch and designed for switching off the power supply means, after a given rest or inactive period of the seismic switch.

### BRIEF DESCRIPTION OF THE DRAWINGS

Further characteristics and advantages of the present invention will become more apparent hereinafter from the following detailed disclosure of a preferred, though not exclusive, embodiment of the invention, which is illustrated, by way of an indicative, but not limitative example, in the accompanying drawings, where:

FIG. 1 is a perspective view of a footwear article including a lighting device according to the present invention;

FIG. 2 is a further perspective view of the lighting device according to the invention;

FIG. 3 is a side elevation view of a footwear article including the lighting device according to the invention;

FIG. 4 is a view similar to FIG. 3, showing the device as it is applied to the footwear article; and

FIG. 5 is a schematic circuit block diagram of the lighting device according to the invention.

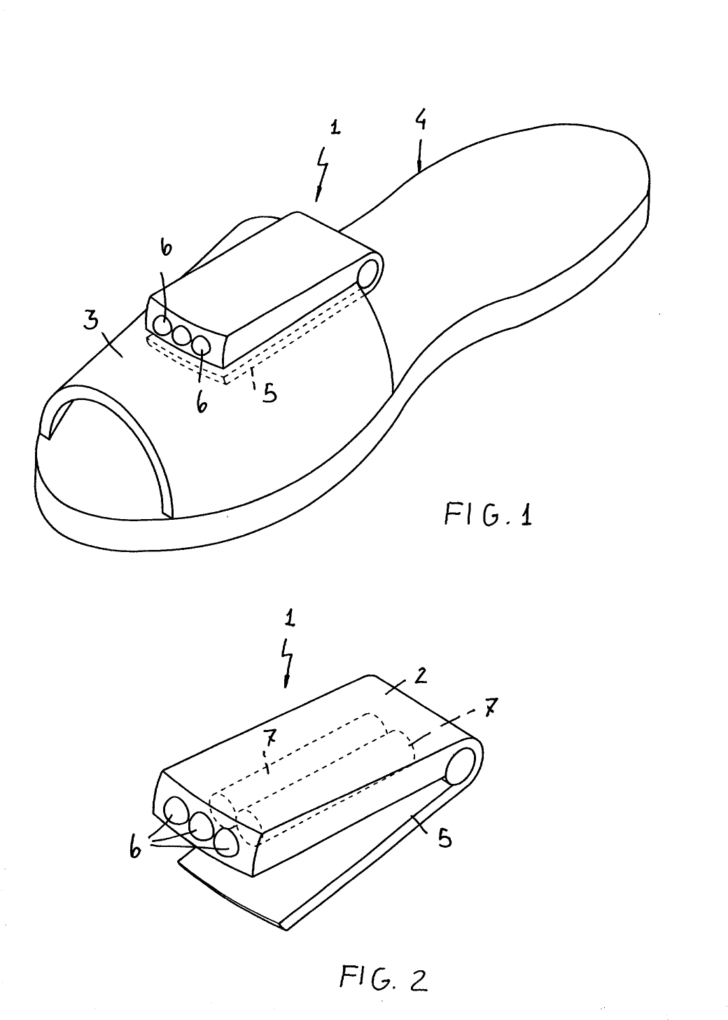

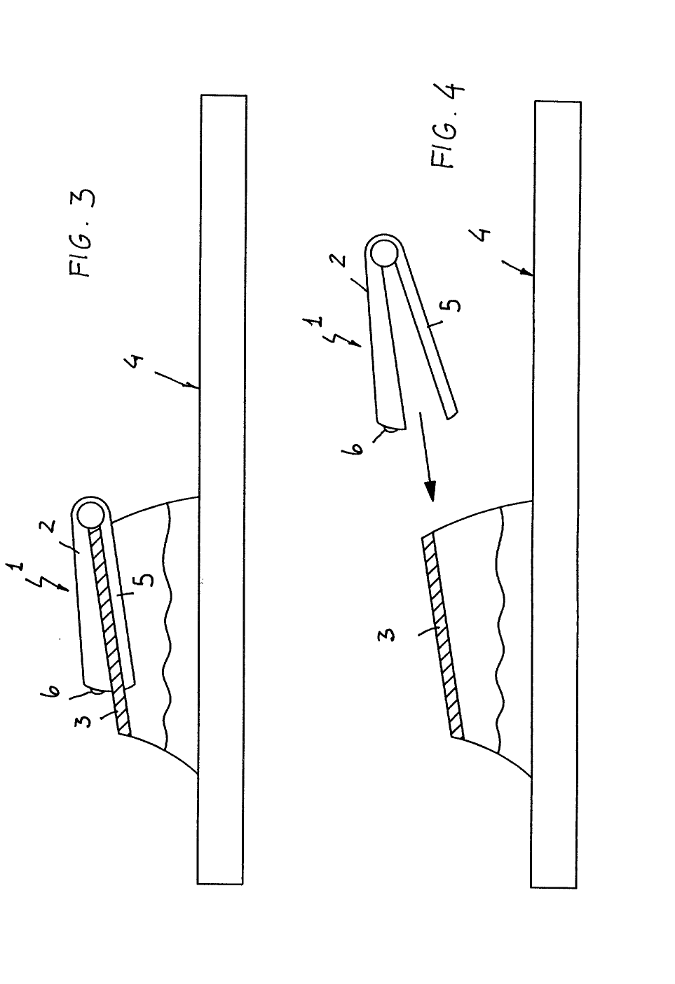

### DESCRIPTION OF THE PREFERRED EMBODIMENT

With reference to the number references of the above mentioned figures, the lighting device according to the present invention, which has indicated by the reference number 1, comprises a holding body 2, which can be applied to a supporting element, such as, for example, the edge portion of an upper 3 of a footwear article 4, such as a slipper or the like.

More specifically, said holding body 2 can be applied to said supporting element by a resilient clip comprising, in the disclosed embodiment, a plate clip 5, which can be resiliently associated with the holding body 2, thereby defining a preferably closed position, due to the provision of a spring or other resilient element, encompassing the supporting element 3.

The holding body 2 holds therein lighting means, which are advantageously constituted by low power consume devices, such as LED diodes 6, power supplied by one or more batteries 7, which are advantageously also housed inside said holding body 2.

The power supply control is performed by a seismic switch, i.e. a switch designed for detecting a displacement or the presence of a user foot in the slipper, to close a dedicated electric circuit.

Advantageously, the mentioned seismic switch and, accordingly, said lighting means, can be actuated or switched on only through a crepuscular switch, designed to supply electric power only as the environment brightness level is less than a preset value.

Moreover, also advantageously, the lighting device according to the invention further comprises timer means, for switching off the lighting means, after a set period from the actuation of the seismic switch.

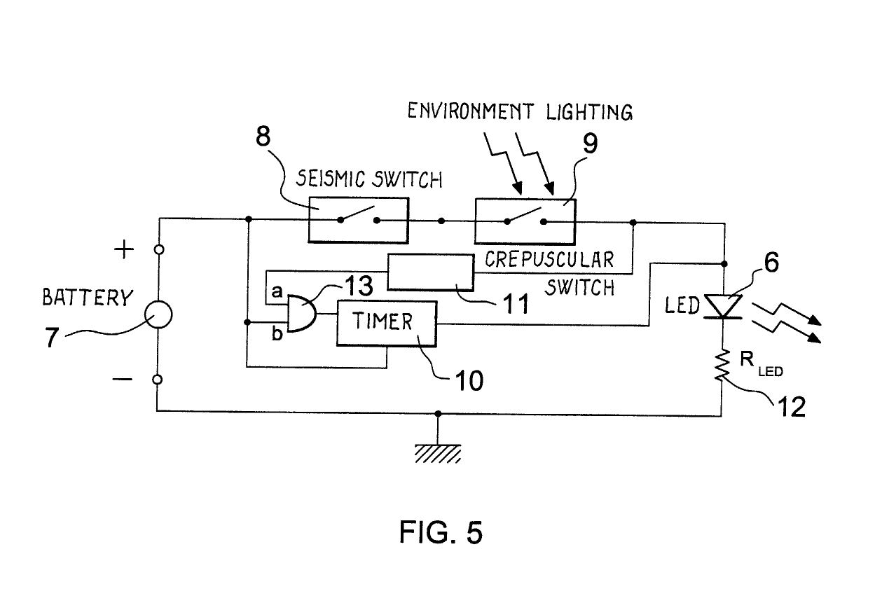

FIG. 5 show an exemplary embodiment of a control circuit for controlling the light beam emitted by the LED diode device 6.

With reference to the circuit diagram shown in FIG. 5, the control system or unit comprises a voltage source, constituted by the battery 7, a seismic switch 8, a crepuscular switch 9, an AND gate 13, a timer 10, a flip-flop 11, a limiting resistor 12 and a LED diode 6.

The battery 7 provides the current required for power supplying the LED diode 6, in the case in which both the seismic switch 8 and crepuscular switch 9 are closed, i.e. in the presence of both a movement and a low level environmental illumination.

In particular, the battery can power supply the LED diode 6 only as the flip-flop 11 input signal switches from a high condition (both said switches 8 and 9 being closed) to a low condition.

At least one of the mentioned switches, actually, is opened as one of the above mentioned conditions is lacking.

The level switching at the input of the flip-flop 11 will provide a high level at the output of said flip-flop and, accordingly, a high level at the input (a) of AND gate 13.

With such a high level, the output of the AND gate 13 will be also at a high level, thereby actuating the timer circuit 10 to power supply the LED diode for a preset period of time.

In particular, the timer or timing circuit 10 can comprise an integrate circuit of the NE555 type, which can be easily obtained on the market.

In general, all the circuit component shown in this exemplary embodiment can be easily found on the market.

The lighting device according to the present invention operates as follows.

After having applied the lighting device to the edge portion or rim of a slipper, or other footwear article, as shown in the figures, it would be sufficient to put a foot in the slipper in order to switch the LED devices on.

Thus, even in a dark condition, it would be sufficient to contact the slipper to actuated the seismic switch thereby switching on the LED's, to allow the slipper to be immediately easily worn.

At the end of the slipper use, the user can remove said slippers, thereby causing the timer to immediately switch the lighting device off.

It has been found that the invention fully achieves the intended aim and objects.

In fact, the invention provides a lighting device which can be easily applied to footwear articles, and which is automatically actuated at the use time.

The device allows the user to easily wear his/her slipper, without the need of switching lamps on, without disturbing other sleeping persons.

The crepuscular switch is designed for actuating the lighting system only as the environment lighting is not sufficient, so as to prevent unnecessary electric power from being consumed.

The provision of the timer, moreover, prevents the user from switching-off the device.

In fact, the latter will be switched-off automatically, a given time upon use, as the seismic switch is not actuated.

The device, furthermore, can be applied to any desired footwear article and, owing to its small size and weight, it can be easily shipped.

Moreover, though the device has been disclosed with reference to an advantageous embodiment thereof, it should be apparent that it can be used in several different applications, such as as an emergency light, when travelling, camping and in any desired places, in which an illumination source does not exist.

In practicing the invention, the used materials, and the contingent size and shapes, can be any, according to requirements and the status of the art.

In this connection it should be further added that the subject lighting device can be built-in in the body of footwear articles and slippers in general.

1. A lighting device, characterized in that said lighting device comprises a holding body which can be applied to a supporting element, such as a footwear article, by a resilient clip, and comprising lighting means power supplied by one or more batteries and driven by a seismic switch controlled by a crepuscular switch designed for supplying electric power only as an environmental brightness level is less than a set value, timer means being moreover provided, actuated by said seismic switch and designed for switching the electric power off after a set rest time of said seismic switch.

2. A lighting device, according to claim 1, characterized in that said lighting means comprise LED diodes.

3. A lighting device, according to claim 1, characterized in that said resilient clip comprises a plate clip which is resiliently pivoted to said holding body.

4. A lighting device, according to claim 1, characterized in that said lighting device further comprises a control circuit including a voltage source, comprising a battery, a seismic switch, a crepuscular switch, an AND gate, a timer means, a flip-flop, a limiting resistor and a LED diode.

5. A lighting device, according to claim 4, characterized in that said battery supplies a current required for power supplying said LED diode, with both said seismic and crepuscular switches being closed.

6. A lighting device, according to claim 4, characterized in that said battery is designed for power supplying said LED diode only as an input signal of said flip-flop switches from a high condition, in which both said switches are closed, to a low condition, in which at least one of said switches is opened since one of said conditions is lacking.

7. A lighting device, according to claim 6, characterized in that said flip-flop input level switching provides a high level at the output of said flip-flop and accordingly a high level at the input of said AND gate.

8. A lighting device, according to claim 7, characterized in that said, in the presence of said level, the high level output of said AND gate actuates said timer circuit for power supplying said LED diode for a set time.
